(19) United States
(12) Patent Application Publication
(10) Pub. No.: US 2016/0372947 A1
(43) Pub. Date: Dec. 22, 2016

(54) CHARGING DEVICE

(71) Applicant: UPI SEMICONDUCTOR CORP., Hsinchu County (TW)

(72) Inventor: Kun-Chang WANG, Hsinchu County (TW)

(21) Appl. No.: 15/080,604

(22) Filed: Mar. 25, 2016

(30) Foreign Application Priority Data
Jun. 18, 2015 (TW) 104209875

(51) Int. Cl. H02J 7/00

(52) U.S. Cl. CPC H02J 7/0042

(57) ABSTRACT

A charging device includes a first body, a second body and a power output unit. The first body includes a first electrode exposed from a surface of the first body and a first magnetic unit disposed at the first body. The second body includes a second magnetic unit and a circuit board, which are disposed in the second body. The power output unit is disposed at the second body. When a plurality of batteries are sandwiched between the first body and the second body, the first electrode, the batteries and the circuit board constitute a circuit to provide power to an electronic device through the power output unit.

### RELATED APPLICATIONS

This application claims priority to Taiwan Application Serial Number 104209875, filed Jun. 18, 2015, which is herein incorporated by reference.

### BACKGROUND

Field of Invention

The present disclosure relates to a charging device. More particularly, the present disclosure relates to a charging device using batteries.

Description of Related Art

With progress and development of electronic technology, functions of electronic products, such as cell phones or tablets, are increased, but power consumption is also increased. Hence, more and more people carry mobile power banks to charge electronic products when chargers are not available. However, the larger capacity the mobile power bank has, the heavier the mobile power bank is. In addition, the mobile power bank cannot be carried while charging. For the forgoing reasons, there is a need for a charging device that is convenient to use, slim and lightweight.

### SUMMARY

An objective of the present disclosure is to provide a charging device that can supply power through batteries. Therefore, compared with the mobile power bank that should be charged for a long time, the charging device of the present disclosure is more convenient to use. In addition, when batteries are not installed in the charging device, two bodies can be attracted to each other through a magnetic unit. Hence, compared with the mobile power bank, the charging device of the present disclosure is slim, lightweight and convenient to carry.

The present disclosure provides a charging device including a first body, a second body and a power output unit. The first body includes a first electrode and a first magnetic unit. The first electrode is exposed from a surface of the first body. The first magnetic unit is disposed at the first body. The second body includes a second magnetic unit and a circuit board The second magnetic unit and the circuit board are disposed in the second body. The power output unit is disposed at the second body. When a plurality of batteries are sandwiched between the first body and the second body, the first electrode, the batteries, and the circuit board constitute a circuit to provide power to an electronic device through the power output unit.

According to one embodiment of the present disclosure, the first body has a first engagement portion protruding from or recessed into the surface of the first body. The second body has a second engagement portion corresponding to the first engagement portion to engage with the first engagement portion.

According to one embodiment of the present disclosure, the first electrode includes two parts separated from each other. The second electrode includes three parts separated from one another. The two parts of the first electrode and the three parts of the second electrode are configured to connect the batteries in series.

According to one embodiment of the present disclosure, the first electrode includes two parts separated from each other. The second electrode includes two parts separated from each other. The two parts of the first electrode and the two parts of the second electrode are configured to connect the batteries in series to form a plurality of battery sets and to connect the battery sets in parallel.

According to one embodiment of the present disclosure, the second magnetic unit is disposed at a surface of the circuit board.

According to one embodiment of the present disclosure, the charging device further includes a power conversion module coupled to the circuit board.

According to one embodiment of the present disclosure, the power output unit includes a connecting wire an adapter. The adapter is connected to the second body through the connecting wire. The first body has a slot configured to accommodate the adapter.

According to one embodiment of the present disclosure, the second body further includes a cover plate. The cover plate has an opening aligned with a positive electrode of one of the batteries. An area encircled by the opening is larger than or equal to a contact area of the positive electrode of the battery but smaller than a contact area of a negative electrode of the battery.

According to one embodiment of the present disclosure, the second body further includes a second electrode exposed from a surface of the second body. The second magnetic unit is disposed between the circuit board and the second electrode.

According to one embodiment of the present disclosure, the second body further includes a second electrode exposed from a surface of the second body. The circuit board is disposed between the second magnetic unit and the second electrode.

The present disclosure further provides a charging device including a first body, a second body and a power output unit. The first body includes a first conductive magnetic unit. The first conductive magnetic unit is exposed from a surface of the first body. The second body includes a second conductive magnetic unit and a circuit board. The second conductive magnetic unit is exposed from a surface of the second body. The circuit board is disposed in the second body. The power output unit is disposed at the second body. When a plurality of batteries are sandwiched between the first body and the second body, the first conductive magnetic unit, the batteries, and the circuit board constitute a circuit to provide power to an electronic device through the power output unit.

### BRIEF DESCRIPTION OF THE DRAWINGS

The invention can be more fully understood by reading the following detailed description of the embodiment, with reference made to the accompanying drawings as follows:

FIG. 1 depicts a structural schematic diagram of a charging device according to one embodiment of the present disclosure;

FIG. 2 depicts an exploded view of the charging device of FIG. 1;

FIG. 3 depicts an exploded view of a charging device according to another embodiment of the present disclosure;

FIG. 4 depicts an exploded view of a charging device according to further embodiment of the present disclosure;

FIG. 5 depicts a schematic diagram of a configuration of a first electrode, a second electrode and batteries according to one embodiment of the present disclosure; and

FIG. 6 depicts a cross-sectional view of a first body and a second body according to one embodiment of the present disclosure.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and elements are schematically depicted in order to simplify the drawings.

An objective of the present disclosure is to provide a charging device that can supply power through batteries. Therefore, compared with the mobile power bank that should be charged for a long time, the charging device of the present disclosure is more convenient to use. In addition, when batteries are not installed in the charging device, two bodies can be attracted to each other through a magnetic unit. Hence, compared with the mobile power bank, the charging device of the present disclosure is slim, lightweight and convenient to carry.

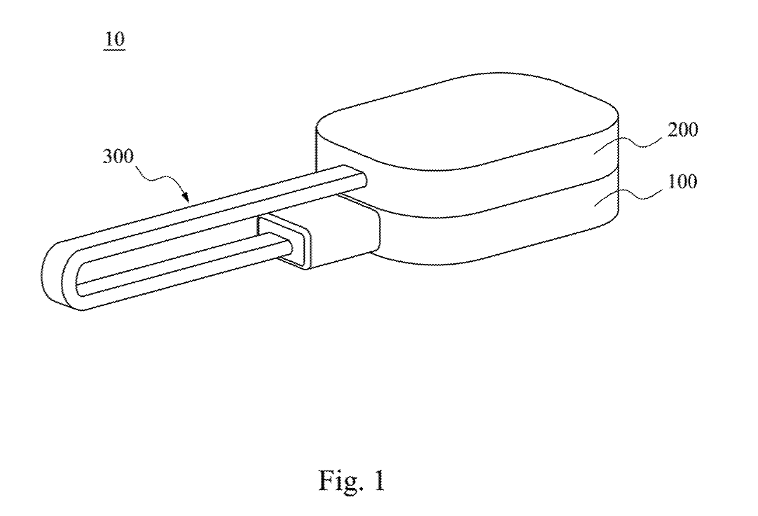

FIG. 1 depicts a structural schematic diagram of a charging device 10 according to one embodiment of the present disclosure. The charging device 10 includes a first body 100, a second body 200 and a power output unit 300.

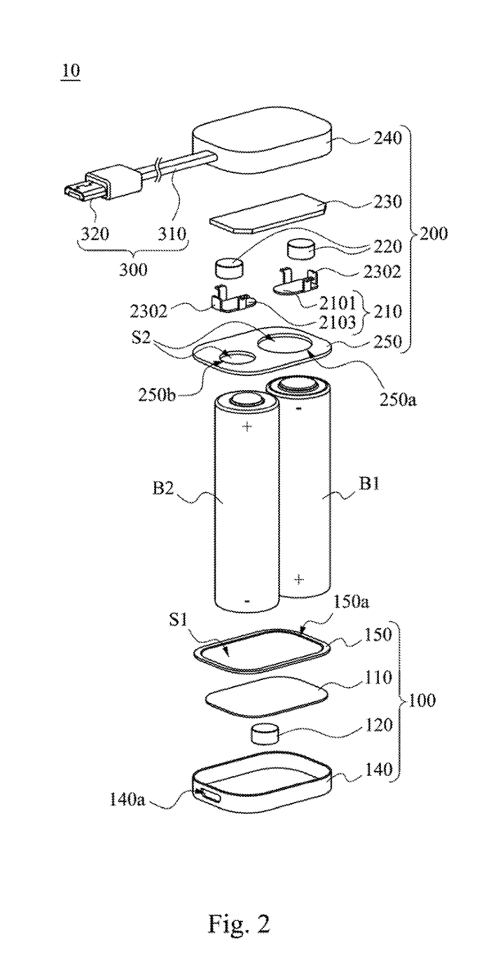

FIG. 2 depicts an exploded view of the charging device 10 of FIG. 1. As shown in FIG. 2, when two batteries B1, B2 are sandwiched between the first body 100 and the second body 200, a circuit is constituted to provide power to an electronic device through the power output unit 300. For example, the batteries B1 B2 may be alkaline batteries, dry batteries, rechargeable batteries, or other types of batteries. For example, the electronic device may be a mobile phone, a tablet or other suitable electronic devices.

Referring to FIG. 2, the first body 100 includes a first electrode 110 and a first magnetic unit 120. In one embodiment, the first body 100 includes not only the first electrode 110 and the first magnetic unit 120 but also a housing 140 and a i cover plate 150.

The first electrode 110 is configured to connect the two batteries B1, B2 in series. The first electrode 110 is exposed from a surface S1 of the first body 100. In one embodiment, the first electrode 110 is a conductive metal or alloy sheet, such as an iron sheet.

The first magnetic unit 120 can attract the first electrode 110. The first magnetic unit 120 can also attract electrodes of the batteries B1, B2. The first magnetic unit 120 is disposed at the first body 100. In one embodiment, the first magnetic unit 120 includes one or more magnets. In one embodiment, as shown in FIG. 2, the first magnetic unit 120 includes one magnet, and the magnet is configured to attract a positive electrode of the battery B1 and a negative electrode of the battery B2 to avoid the batteries B1, B2 separating from the charging device 10 while charging.

The housing 140 and the cover plate 150 enclose a space for accommodating the first electrode 110 and the first magnetic unit 120. The cover plate 150 faces the two batteries B1, B2. The housing 140 and the cover plate 150 may be made of insulating materials, such as a plastic material. In one embodiment, the cover plate 150 has an opening 150a. The positive electrode of the battery B1 and the negative electrode of the battery B2 are in contact with the first electrode 110 through the opening 150a.

Still referring to FIG. 2, the second body 200 faces the first body 100, and the second body 200 includes a second magnetic unit 220 and a circuit board 230. In one embodiment, the second body 200 includes not only the second magnetic unit 220 and the circuit board 230 but also a second electrode 210, a housing 240 and a cover plate 250.

The second electrode 210 is exposed from a surface S2 of the second body 200. In one embodiment, the second electrode 210 may be a conductive metal or alloy sheet, such as an iron sheet. In one embodiment, as shown in FIG. 2, the second electrode 210 includes two parts 2101, 2103 separated from each other. A negative electrode of the battery B1 is in contact with the part 2101 of the second electrode 210 through an opening 250a. A positive electrode of the battery B2 is in contact with the part 2103 of the second electrode 210 through an opening 250b.

The second magnetic unit 220 is configured to attract the first magnetic unit 120, and thus the second magnetic unit 220 and the first magnetic unit 120 can be attracted to each other and assembled as the structure shown in FIG. 1 when the batteries are not installed. The second magnetic unit 220 is disposed in the second body 200. In one embodiment, the second magnetic unit 220 includes one or more magnets. In one embodiment, as shown in FIG. 2, the second magnetic unit 220 includes two magnets, and the two magnets are configured to respectively attract the negative electrode of the battery B1 and the positive electrode of the battery B2 to avoid the batteries B1, B2 separating from the charging device 10 while charging.

The circuit board 230 is disposed in the second body 200. The first electrode 110, the batteries B1, B2 and the circuit board 230 constitute a circuit.

In one embodiment, the circuit board 230 includes two sets of pins 2302. The two parts 2101, 2103 of the second electrode 210 are respectively coupled to the circuit board 230 through the two sets of the pins 2302. In one embodiment, the circuit board 230 includes solder joints (not shown). The pins 2302 are coupled to the circuit board 230 through the solder joints. The pins 2302 may be metal sheets, such as iron sheets, which can attract the second magnetic unit 220. In one embodiment, the second magnetic unit 220 is disposed at a surface of the circuit board 230. In one embodiment, the second magnetic unit 220 is fixed to the circuit board 230 through surface mounting technology (SMT). In one embodiment, the second magnetic unit 220 is disposed between the circuit board 230 and the second electrode 210. In other embodiments, the circuit board is disposed between the second magnetic unit and the second electrode.

In one embodiment, the charging device 10 further includes a power conversion module (not shown) coupled to the circuit board 230. The power conversion module is configured to convert a voltage provided by the batteries connected in series to an input voltage required by the electronic product. In one embodiment, the power conversion module is disposed on the circuit board 230. In one embodiment, the power conversion module is disposed in the power output unit 300.

The housing 240 and the cover plate 250 enclose a space for accommodating the second electrode 210, the second magnetic unit 220 and the circuit board 230. The cover plate 250 faces the two batteries B1, B2. The housing 240 and the cover plate 250 may be made of insulating materials, such as a plastic material. In one embodiment, the cover plate 250 has two openings 250a, 250b separated from each other.

In one embodiment, the cover plate 250 has an opening aligned with the positive electrode of one of the two batteries B1, B2, and an area encircled by the opening is larger than or equal to a contact area of the positive electrode of the battery but smaller than a contact area of the negative electrode of the battery. Here the “contact area” refers to a contact area of the positive or negative electrode of the battery in contact with the second electrode 210. As shown in FIG. 2, the opening 250b of the cover plate 250 is aligned with the positive electrode of the battery B2. An area encircled by the opening 250b is larger than or equal to a contact area of the positive electrode of the battery B2 but smaller than a contact area of the negative electrode of the battery B2. As such, a closed circuit will not be formed when one of the batteries B1, B2 is reversely installed.

Still referring to FIG. 2, the power output unit 300 includes a connecting wire 310 and an adapter 320. The adapter 320 is connected to the second body 200 through the connecting wire 310. In practical applications, the suitable adapter 320 can be selected depending on the electronic product to be charged; specifically, for example, a USB adapter, a mini USB adapter, a micro USB adapter or a lightning adapter, etc. In other embodiments, other adapters, such as a crocodile clip, a coaxial cable, etc., can also be used, but not limited thereto.

In one embodiment, the housing 140 of the first body 100 has a slot 140a for accommodating the adapter 320, such that the charging device 10 is more convenient to carry.

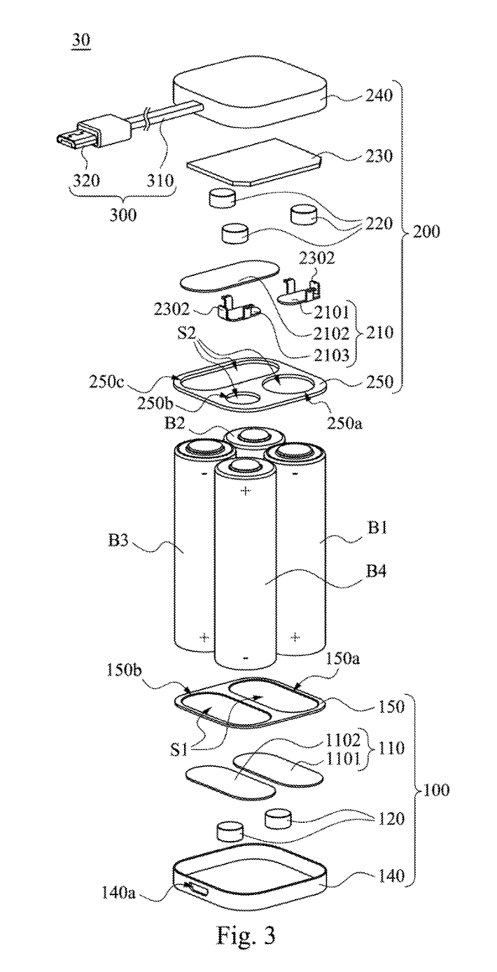

FIG. 3 depicts an exploded view of a charging device 30 according to another embodiment of the present disclosure. The charging device 30 includes a first body 100, a second body 200 and a power output unit 300. A main difference between FIG. 3 and FIG. 2 is that in FIG. 3, there are four batteries B1, B2, B3, B4 sandwiched between the first body 100 and the second body 200.

Referring to FIG. 3, the first body 100 includes the first electrode 110 and the first magnetic unit 120. In one embodiment, the first body 100 includes not only the first electrode and the first magnetic unit 120 but also a housing 140 and a cover plate 150.

The first electrode 110 is configured to connect the two batteries B1, B2 and the two batteries B3, B4 in series. The first electrode 110 is exposed from a surface S1 of the first body 100. In one embodiment, the first electrode 110 includes two parts 1101, 1102 separated from each other. The part 1101 of the first electrode 110 is configured to connect the batteries B1, B2 in series. The part 1102 of the first electrode 110 is configured to connect the batteries B3, B4 in series. In one embodiment, the first electrode 110 may be a conductive metal or alloy sheet, such as an iron sheet.

The first magnetic unit 120 can attract the first electrode 110. The first magnetic unit 120 is disposed in the first body 110. In one embodiment, as shown in FIG. 3, the first magnetic unit 120 includes two magnets respectively attract the part 1101 and the part 1102 of the first electrode 110.

The housing 140 and the cover plate 150 enclose a space for accommodating the first electrode 110 and the first magnetic unit 120. The cover plate 150 faces the four batteries B1, B2, B3, B4. The housing 140 and the cover plate 150 may be made of insulating materials, such as a plastic material. In one embodiment, the cover plate 150 has an opening 150a and an opening 150b. A positive electrode of the battery B1 and a negative electrode of the battery B2 are in contact with the part 1101 of the first electrode 110 through the opening 1508. A positive electrode of the battery B3 and a negative electrode of the battery B4 are in contact with the part 1102 of the first electrode 110 through the opening 150b.

Still referring to FIG. 3, the second body 200 faces the first body 100, and the second body 200 includes a second magnetic unit 220 and a circuit board 230. In one embodiment, the second body 200 includes not only the second magnetic unit 220 and the circuit board 230 but also a second electrode 210, a housing 240 and a cover plate 250.

One part of the second electrode 210 is configured to connect the batteries B2, B3 in series. In one embodiment, the second electrode 210 includes three parts 2101, 2102, 2103 separated from one another. The part 2102 of the second electrode 210 is configured to connect the batteries B2, B3 in series. In other words, the two parts 1101, 1102 of the first electrode 110 and the three parts 2101, 2102, 2103 of the second electrode 210 are configured to connect the batteries B1, B2, B3, B4 in series. In one embodiment, the second electrode 210 may be a conductive metal or alloy sheet, such as an iron sheet.

The second magnetic unit 220 is configured to attract the first magnetic unit 120, and thus the second magnetic unit 220 and the first magnetic unit 120 can be attracted to each other and assembled when the batteries are not installed. The second magnetic unit 220 is disposed in the second body 200. In one embodiment, as shown in FIG. 3, the second magnetic unit 220 includes three magnets, and the three magnets can respectively attract a negative electrode of the battery B1, a positive electrode of the battery B4, and both a positive electrode of the battery B2 and a negative electrode of the battery B3.

The circuit board 230 is disposed in the second body 200. The first electrode 110, the batteries B1, B2, B3, B4, the second electrode 210 and the circuit board 230 constitute a circuit. In one embodiment, the circuit board 230 includes two sets of pins 2302. The parts 2101, 2103 of the second electrode 210 are respectively coupled to the circuit board 230 through the two sets of pins 2302. In one embodiment, the circuit board 230 includes solder joints (not shown), and the pins 2302 are coupled to the circuit board 230 through the solder joints. The pins 2302 may be metal sheets, such as iron sheets, which can attract the second magnetic unit 220. In one embodiment, the second magnetic unit 220 is disposed on a surface of the circuit board 230. In one embodiment, the second magnetic unit 220 is fixed to the circuit board 230 through surface mounting technology. In one embodiment, the second magnetic unit 220 is disposed between the circuit board 230 and the second electrode 210. In other embodiments, the circuit board is disposed between the second magnetic unit and the second electrode.

In one embodiment, the charging device 30 further includes a power conversion module (not shown) coupled to the circuit board 230. The power conversion module is configured to convert a voltage provided by the batteries connected in series to an input voltage required by an electronic product. In one embodiment, the power conversion module is disposed on the circuit board 230. In one embodiment, the power conversion module is disposed in the power output unit 300.

The housing 240 and the cover plate 250 enclose a space for accommodating the second electrode 210 and the second magnetic unit 220.

The cover plate 250 faces the four batteries B1, B2, B3, B4. The housing 240 and the cover plate 250 may be made of insulating materials, such as a plastic material. In one embodiment, the cover plate 250 has the openings 250a, 250b, 250c. The negative electrode of the battery B1 is in contact with the part 2101 of the second electrode 210 through the opening 250a. The positive electrode of the battery B2 and the negative electrode of the battery B3 are in contact with the part 2102 of the second electrode 210 through the opening 250c. The positive electrode of the battery B4 is in contact with the part 2103 of the second electrode 210 through the opening 250b.

In one embodiment, the cover plate 250 has an opening aligned with the positive electrode of one of the four batteries B1, B2, B3, B4. An area encircled by the opening is larger than or equal to a contact area of the positive electrode of the battery but smaller than a contact area of the negative electrode of the battery. As shown in FIG. 3, the opening 250b of the cover plate 250 is aligned with the positive electrode of the battery B4. An area encircled by the opening 250b is larger than or equal to a contact area of the positive electrode of the battery B4 but smaller than a contact area of the negative electrode of the battery B4. As such, a closed circuit will not be formed when one of the batteries B1, B2, B3, B4 is reversely installed.

Still referring to FIG. 3, the power output unit 300 includes a connecting wire 310 and an adapter 320. The adapter 320 is connected to the second body 200 through the connecting wire 310.

In one embodiment, the housing 140 of the first body 100 has a slot 140a for accommodating the adapter 320, such that the charging device 30 is more convenient to carry.

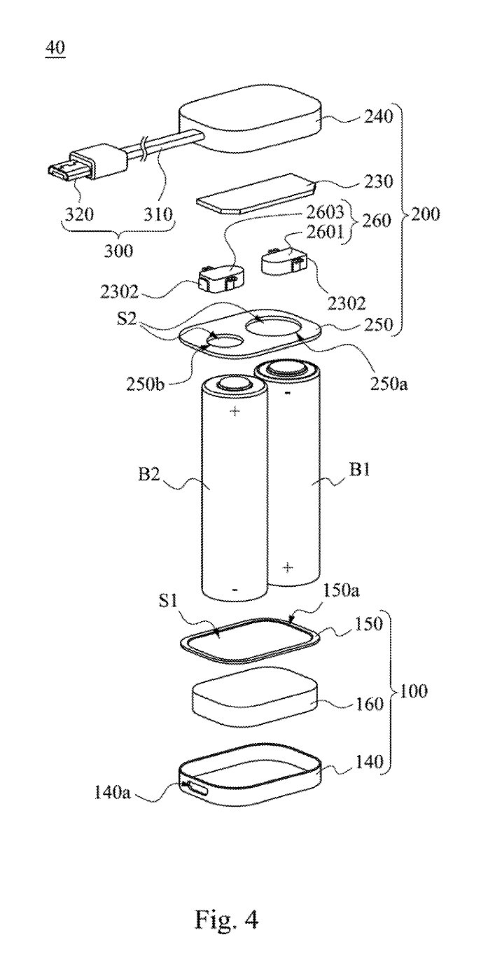

FIG. 4 depicts an exploded view of a charging device 40 according to further embodiment of the present disclosure. The main difference between FIG. 4 and FIG. 2 is that the embodiment of FIG. 4 includes a first conductive magnetic unit 160 and a second conductive magnetic unit 260. The first conductive magnetic unit 160 is exposed from a surface S1 of a first body 100. The second conductive magnetic unit 260 is exposed from a surface S2 of a second body 200. When a plurality of batteries (such as the batteries B1, B2) are sandwiched between the first body 100 and the second body 200, the first conductive magnetic unit 160, the batteries and the circuit board 230 constitute a circuit to provide power to an electronic device through the power output unit 300.

Specifically, a function of the first conductive magnetic unit 160 is equal to that of the first electrode 110 and that of the first magnetic unit 120 of FIG. 2. A function of the second conductive magnetic unit 260 is equal to that of the second electrode 210 and that of the second magnetic unit 220 of FIG. 2. The second conductive magnetic unit 260 has two parts 2601, 2603. In one embodiment, both the first conductive magnetic unit 160 and the second conductive magnetic unit 260 are conductive magnets.

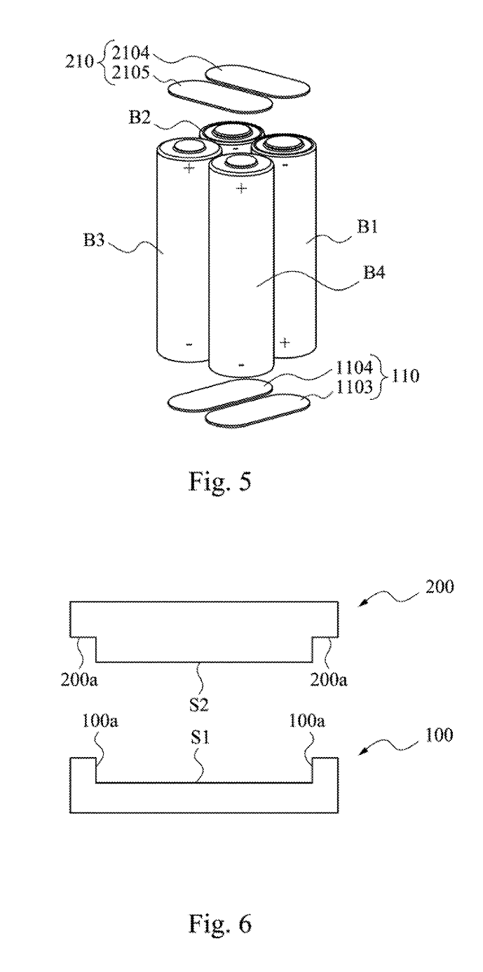

FIG. 5 depicts a schematic diagram of a configuration of the first electrode 110, the second electrode 220 and the batteries B1, B2, B3, B4 according to one embodiment of the present disclosure. The main difference between FIG. 5 and FIG. 3 is the configuration of the first electrode 110 and the second electrode 210. The first electrode 110 includes two parts 1103, 1104. The second electrode 210 includes two parts 2104, 2105. The batteries B1, B4 are connected in series through the part 1103 to form a battery set. The batteries B2, B3 are connected in series through the part 1104 to form another battery set. The battery set constituted by the batteries B1, B4 is then connected in parallel with the battery set constituted by the batteries B2, B3 through the parts 2104, 2105, In other words, the two parts 1103, 1104 of the first electrode 110 are configured to connect the batteries B1, B2, B3, B4 in series to form two battery sets. The two parts 2104, 2105 of the second electrode 210 are configured to connect the two battery sets in parallel.

FIG. 6 depicts a cross-sectional view of a first body 100 and a second body 200 according to one embodiment of the present disclosure. The first body 100 has a first engagement portion protruding from or recessed into a surface of the first body, and the second body 200 has a second engagement portion 200 corresponding to the first engagement portion to engage with the first engagement portion. As shown in FIG. 6, the first engagement portion 100a protrudes from the surface S1 of the first body 100. The second engagement portion 200a is recessed into the surface S2 of the second body 200. The second engagement portion 200a can be engaged with the first engagement portion 100a. As such, after installing the batteries, the batteries are not easy to fall.

Although the present disclosure and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein ay be utilized according to the present disclosure.

What is claimed is:

1. A charging device comprising:
a first body comprising a first electrode and a first magnetic unit, the first electrode being exposed from a surface of the first body, the first magnetic unit being disposed at the first body;
a second body comprising a second magnetic unit and a circuit board, the second magnetic unit and the circuit board being disposed in the second body; and
a power output unit disposed at the second body,
wherein when a plurality of batteries are sandwiched between the first body and the second body, the first electrode, the batteries, and the circuit board constitute a circuit to provide power to an electronic device through the power output unit.

2. The charging device of claim 1, wherein the first body has a first engagement portion protruding from or recessed into the surface of the first body, and the second body has a second engagement portion corresponding to the first engagement portion to engage with the first engagement portion.

3. The charging device of claim 1, wherein the first electrode comprises two parts separated from each other, and the second electrode comprises three parts separated from one another, and the two parts of the first electrode and the three parts of the second electrode are configured to connect the batteries in series.

4. The charging device of claim 1, wherein the first electrode comprises two parts separated from each other, and the second electrode comprises two parts separated from each other, and the two parts of the first electrode and the two parts of the second electrode are configured to connect the batteries in series to form a plurality of battery sets and to connect the battery sets in parallel.

5. The charging device of claim 1, wherein the second magnetic unit is disposed at a surface of the circuit board.

6. The charging device of claim 1, further comprising a power conversion module coupled to the circuit board.

7. The charging device of claim 1, wherein the power output unit comprises a connecting wire and an adapter, and the adapter is connected to the second body through the connecting wire, and the first body has a slot configured to accommodate the adapter.

8. The charging device of claim 1, wherein the second body further comprises a cover plate, and the cover plate has an opening aligned with a positive electrode of one of the batteries, and an area encircled by the opening is larger than or equal to a contact area of the positive electrode of the battery but smaller than a contact area of a negative electrode of the battery.

9. The charging device of claim 1, wherein the second body further comprises a second electrode exposed from a surface of the second body, and the second magnetic unit is disposed between the circuit board and the second electrode.

10. The charging device of claim 1, wherein the second body further comprises a second electrode exposed from a surface of the second body, and the circuit board is disposed between the second magnetic unit and the second electrode.

11. A charging device comprising:
a first body comprising a first conductive magnetic unit, the first conductive magnetic unit being exposed from a surface of the first body;
a second body comprising a second conductive magnetic unit and a circuit board, the second conductive magnetic unit being exposed from a surface of the second body, the circuit board being disposed in the second body; and
a power output unit disposed at the second body;
wherein when a plurality of batteries are sandwiched between the first body and the second body, the first conductive magnetic unit, the batteries and the circuit board constitute a circuit to provide power to an electronic device through the power output unit.
